(19) United States
(12) Patent Application Publication
(10) Pub. No.: US 2024/0218968 A1
(43) Pub. Date: Jul. 4, 2024

(54) CORNER WALL MOUNT

(71) Applicant: Izrael Bonds, Warrensburg, MO (US)

(72) Inventor: Izrael Bonds, Warrensburg, MO (US)

(21) Appl. No.: 18/144,115

(22) Filed: May 5, 2023

Related U.S. Application Data
(60) Provisional application No. 63/436,581, filed on Dec. 31, 2022.

(51) Int. Cl. F16M 13/02; A47B 97/00

(52) U.S. Cl. CPC F16M 13/025; A47B 97/001; F16M 13/022

(57) ABSTRACT

A corner wall mount includes an anchoring base with hinged base plates for attaching the wall mount to adjoining walls at a corner of a room. An extendable scissor arm extends outward from the anchoring base plate into the room and holds a frame clamp. The extendable scissor arm may be pulled to extend further or pushed to collapse toward the wall. The frame clamp is provided for holding a picture frame or the like, or any generally flat, rectangular object such as a plaque. The extendable scissor arm may be pivoted to swing between the base plates and the frame clamp may be similarly pivoted or rotated transverse to the extendable scissor arm to rotate the frame or other item held within.

### CROSS REFERENCE TO RELATED APPLICATIONS

This application claims the benefit of the prior-filed, co-pending provisional patent application, Ser. No. 63/436,581, filed Dec. 31, 2022, incorporated herein by reference.

### FIELD OF THE INVENTION

The present invention relates to picture frames and wall hanging devices, and more particularly to a corner wall mount for holding picture frames or other flat objects upon adjoining wall surfaces in the corner of a room.

### BACKGROUND OF THE INVENTION

While many picture frames, paintings and other flat decorative items (referred to generally herein as “frame” or “frames”) are typically mounted on flat walls, there are instances where it may be desired to have a frame mounted at a corner location, spanning two walls to face outward from the corner at approximately 45 degrees. While this mounting configuration may seem simple, achieving this type of mounting with accuracy and aesthetics can be difficult to achieve using mounting hardware in the prior art. Even through the use of elaborate brackets and spanning cable wire, the attempt to hang a frame in a corner location can create wall damage, and can reveal an unprofessional installation due to the nature of suspending a frame between two adjoining walls.

Therefore, there exists a need for a device for mounting a picture frame or the like at an approximate 45-degree position while spanning the adjoining walls of a room corner.

### SUMMARY OF THE INVENTION

Embodiments of the present invention comprise, in part, a hinged, anchoring base, an extendable arm attached to the base, and a pivoting frame clamp or cradle to form a wall mount for frames. A frame selected by the user may be mounted between cooperating jaws of the frame clamp to hold the frame upon the wall mount. The anchoring base comprises two mounting base plates, hinged to one another at the hinge knuckles and attached to one another by a hinge pin, each base plate with corner through-holes to accept screws or other attachment devices to anchor the base plates to adjoining wall surfaces. The hinge knuckles and hinge pin are typically centrally located between the base plates, which are typically of the same or similar size. The area of the hinge knuckles and hinge pin may be referred to herein as “the hinge.”

The extendable arm attaches at and typically below the hinge knuckles and extends from the hinge pin. The extendable arm may rotate or swivel about the axis of the hinge pin between the base plates. The extendable arm (also referred to as a scissor arm) comprises scissor rods pivotally attached to one another so that the scissor arm may open or close to extend or retract the frame from the wall surface upon which the wall mount is anchored.

Typically, screws are used to anchor the base plates to wall surfaces. To anchor the base plates at the corner of the room, the base plates are rotated via the hinge so that they are substantially at a 90-degree disposition relative to one another. However, the base plates may be rotated to a 180-degree disposition if the wall mount is to be anchored to a flat wall versus at a corner.

The wall mount may be produced by any process and from any operable resilient material. Typical production may include thermoplastic injection molding of wall mount components. Hard plastics, including a thermoplastic polymer such as acrylonitrile butadiene styrene (ABS), a recycled composite material, or a high-density polyethylene (HDPE) may be used. Such plastics are typically available in a wide range of colors, and wall mount may be produced in a variety of sizes.

Certain embodiments of a wall mount according to the present invention may include an anchoring base having one or more base plates for attaching the anchoring base to a wall, or to adjoining walls at the corner of a room: an extendable arm attached to the anchoring base at a proximate end of the extendable arm so that the extendable arm projects outward from the anchoring base; and, a frame clamp attached to a distal end of the extendable arm for holding picture frames or the like within the frame clamp for display. In certain embodiments, the anchoring base comprises base plates attached to one another at a substantially ninety-degree angle for attaching the base plates to adjoining walls at the corner of a room.

In certain embodiments, the anchoring base may include two base plates hingedly connected to one another, with the base plates pivotable around the axis of the hinge to attain angles relative to one another from approximately 180 degrees to approximately 90 degrees. Holes may be provided in the base plates to accept screws or similar attachment devices to anchor the base plates to one or more wall surfaces. Attachment devices may include nails or threaded bolts, but in most installations will comprise screws selected for operability as known in the art with the particular wall surface (e.g. drywall screws for drywall, wood screws for wood wall surfaces, etc.). The extendable arm may comprise scissoring sub-structures, such as scissor rods pivotally attached to one another, for allowing said extendable arm to extend or contract/retract in length as the scissor rods pivot relative to one another.

The extendable arm pivots around the axis of the hinge so that said extendable arm may be pivoted to any selected position along the arc between the two base plates. The base plates may be hingedly connected to one another at the hinge knuckles of each base plate by a hinge pin passing through axially aligned bores in the hinge knuckles. The extendable arm may be attached to a base plate or, if pivoting, to the hinge pin so that it may pivot around the hinge pin.

A frame clamp is attached to the distal end of the extendable arm. A pivoting frame clamp is pivotally attached to the distal end of the extendable arm at a pivoting point. The frame clamp includes cooperating jaws that may be selectively opened or closed relative to one another to reduce or enlarge the space therebetween for holding a photo, painting or other rigid frame of any sort. If the wall mount includes a pivoting frame clamp, the frame clamp may be rotated about the pivoting point. In certain embodiments, the frame clamp is tiltable up or down, or side to side about the pivoting point.

The main structural elements of the wall mount are typically formed from a resilient material such as metal or plastic. More typically, the wall mount comprises a thermoplastic material and the structural elements are primarily formed by injection molding as is known in the art.

Other advantages of the invention will become apparent from the following description taken in connection with the accompanying drawings, wherein is set forth by way of illustration and example several embodiments of the present invention.

### BRIEF DESCRIPTION OF THE DRAWINGS

FIG. 1 is a top, left perspective view of a corner wall mount showing the mounting base plates in a fully open position, the extendable arm in a partially retracted position, and a frame mounted within the frame clamp.

FIG. 2 is a top, left perspective view of a corner wall mount showing the mounting base plates in a partially closed position, as for mounting in a wall corner, the extendable arm in a fully extended position, and a frame mounted within the frame clamp.

FIG. 3 is a top plan view of the corner wall mount in the same disposition as in FIG. 1.

FIG. 4 is a top plan view of the corner wall mount in the same disposition as in FIG. 2.

FIG. 5 is top, left perspective view of a corner wall mount showing the mounting base plates in a partially open position, the extendable arm in a partially retracted position, and a frame mounted within the frame clamp.

FIG. 6 is a bottom, rear, right perspective view of the corner wall mount in the same disposition as in FIG. 5 and showing the attachment of the extendable arm to the anchoring base hinge.

FIG. 7 is a top plan view of the corner wall mount in the same disposition as in FIGS. 5 and 6.

FIG. 8 is a bottom plan view of the corner wall mount in the same disposition as in FIGS. 5 and 6.

FIG. 9 is a right elevation view of the corner wall mount in the same disposition as shown in FIGS. 5, 6 and 7.

FIG. 10 is a left elevation view of the corner wall mount in the same disposition as shown in FIGS. 5, 6 and 7. [correction needed to hinge portion]

FIG. 11 is right elevation view showing the extendable arm of the corner wall mount fully retracted.

FIG. 12 is right elevation view showing the extendable arm of the corner wall mount fully extended.

FIG. 13 is an environmental view showing the corner wall mount installed upon adjoining walls at the corner of a room.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

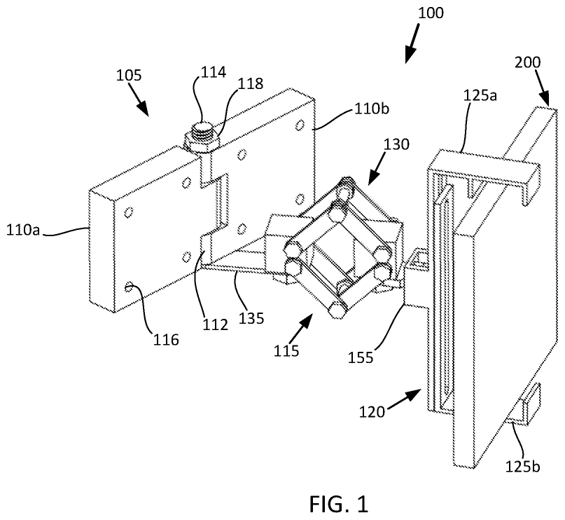

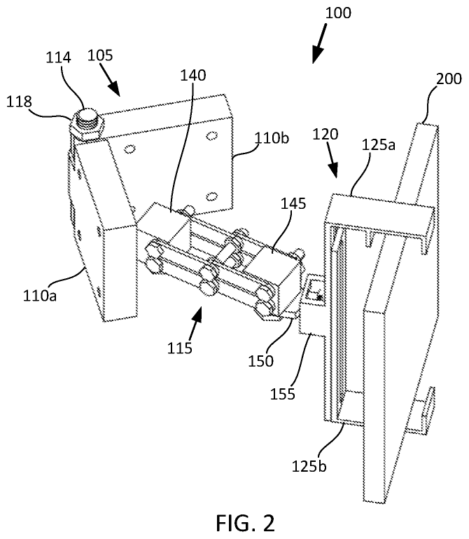

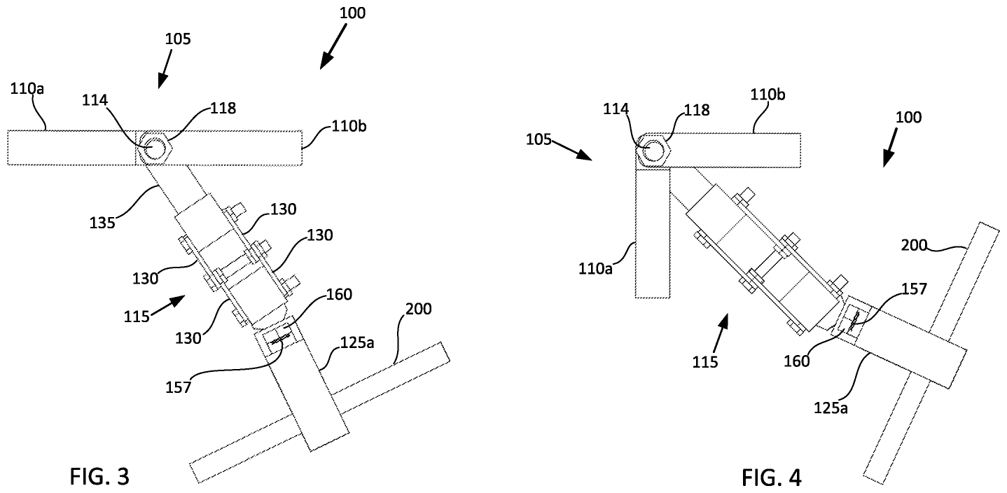

FIG. 1 is an enlarged, front, right perspective view illustrating components of an embodiment of a wall mount 100 of the present invention. An embodiment of a wall mount 100 according to the present invention may comprise, in part, a hinged, anchoring base 105, typically formed from two hinged, cooperating, mounting base plates 110a and 110b (110 collectively), an extendable arm 115 attached to the base, and a pivoting frame clamp or cradle 120. A frame 200, such as a frame holding a photograph, drawing or painting, selected by a user may be mounted between cooperating jaws 125a and 125b of the frame clamp 120 to hold the frame 200 upon the wall mount 100.

The anchoring base 105 typically comprises two mounting base plates 110, hinged to one another at the hinge knuckles 112 and attached to one another by a hinge pin 114 passing through axially aligned bores (not shown) in the hinge knuckles 112, as is known in the art. The hinge knuckles 112 and hinge pin 114 are typically centrally located between the base plates 110, which are typically of the same or similar size. The hinge pin 114 may include a threaded end so that it may be secured in place by threaded engagement with a nut 118.

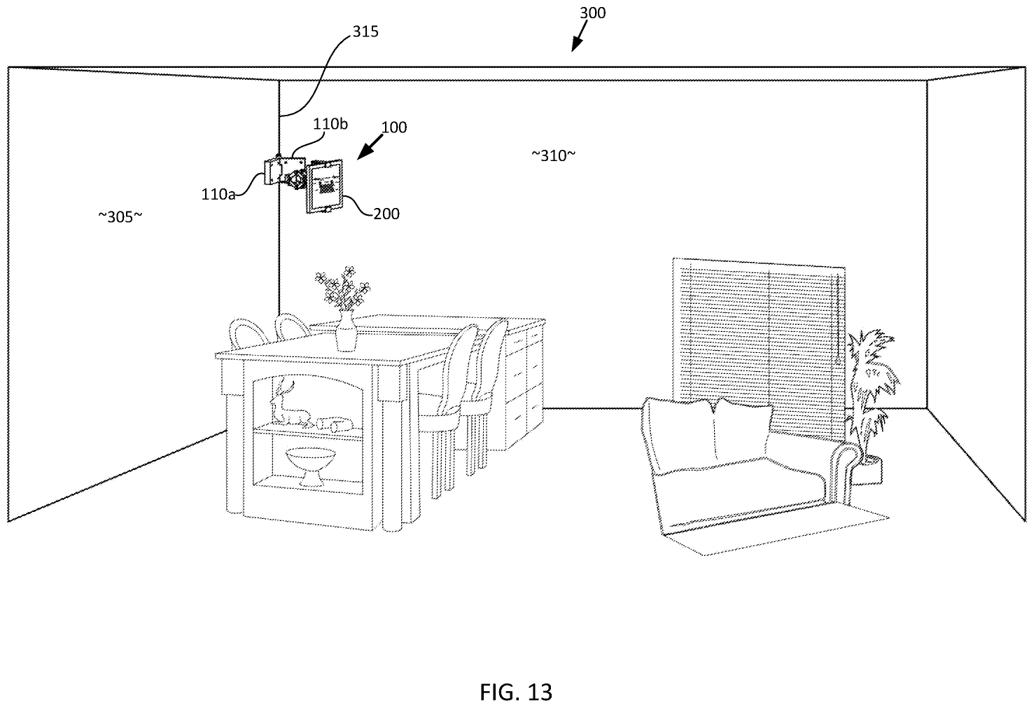

Each base plate 110 includes through-holes 116, typically located proximate base plate corners, to accept screws or other attachment devices to anchor the base plates 110 to adjoining wall surfaces 305 and 310. FIG. 13 is an environmental view showing the wall mount 100 installed upon adjoining walls 305 and 310 at the corner of a room 300. As shown, a first base plate 110a is attached to a first wall 305 proximate a room corner 315, and a second base plate 110b is attached to adjoining wall 310.

The extendable arm 115 attaches at and typically below the hinge knuckles 112 and extends from the hinge pin 114. The extendable arm 115 may therefore pivot, rotate or swivel about the axis of the hinge pin 114 between whatever space is available between the base plates 110, i.e. to any selected position along the arc between said two base plates. The extendable arm 115 may comprise scissoring sub-structures so that it may be of the type sometimes referred to in the art as a scissor arm. As shown in the figures, the extendable arm 115 comprises scissor rods 130 pivotally attached to one another so that the extendable arm 115 may open or close to retract or extend the frame clamp 120 and frame 200 closer to or further from the wall surface upon which the wall mount 100 is anchored.

Typically, screws (not shown) are used to anchor the base plates 110 to wall surfaces 305, 310. To anchor the base plates 110 at the corner 315 of the room, the base plates 110 are rotated via the hinge so that they are substantially at a 90-degree disposition relative to one another. However, the base plates 110 may be rotated to a 180-degree disposition if the wall mount 100 is to be anchored to an entirely flat wall surface versus at a corner.

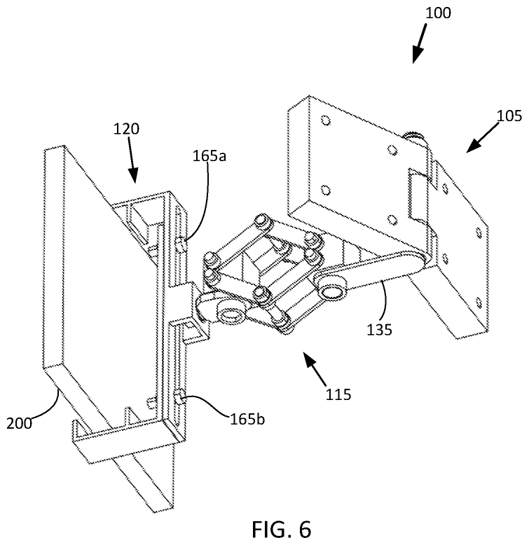

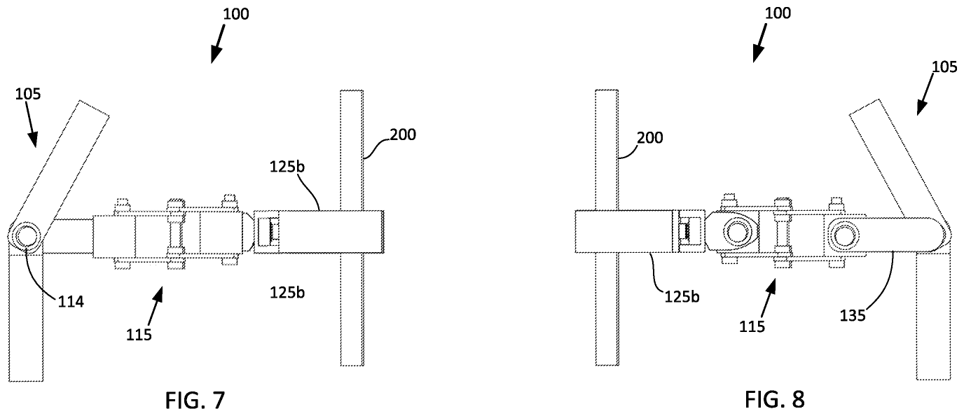

With further reference to the extendable arm 115, it may comprise several components to allow it to swivel left or right relative to the anchoring base 105, extend outward from, or closer to, the anchoring base 105, and to allow the frame clamp 120 to swivel left or right relative to the extendable arm 115 itself. Such components may include a a substantially flat, rectangular first sub-arm 135 that extends from the hinge and attaches to the hinge pin 114 (see FIGS. 6 and 8). The first sub-arm 135 may be attached via any operable means to the hinge pin 114, including via adhesive, by threadable engagement between a male threaded portion of the hinge pin 114 and a female threaded aperture in the sub-arm 135, by passing a screw or machine bolt through a small aperture in the sub-arm 135 into a small threaded aperture in the proximate end of the hinge pin 114, or by other means for attachment known in the art.

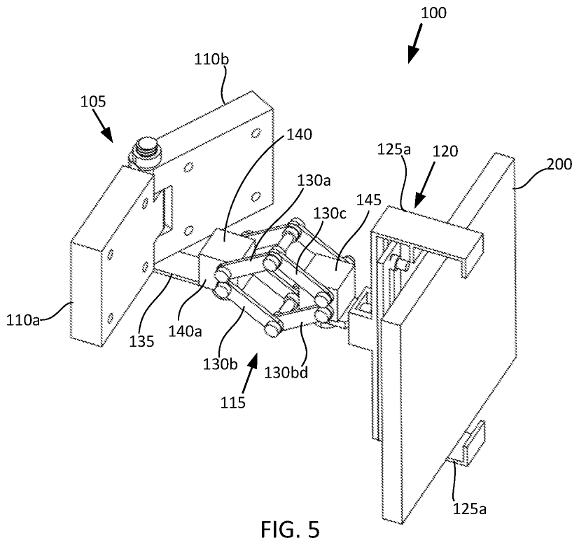

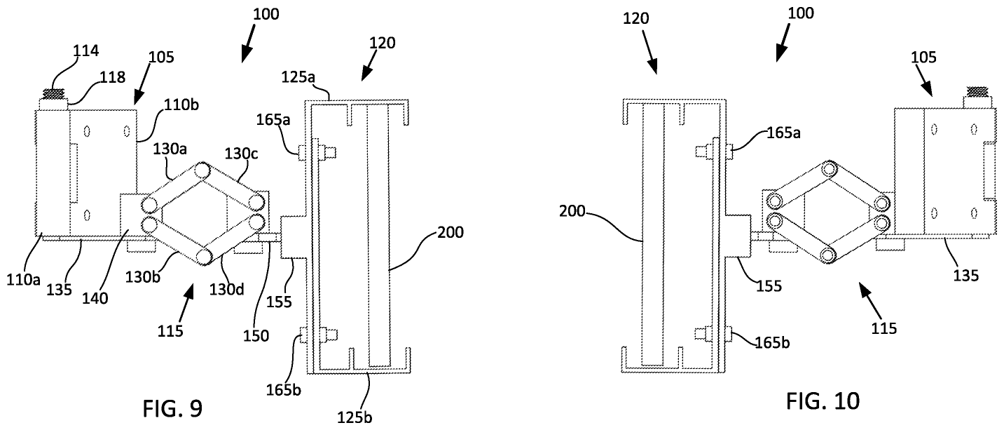

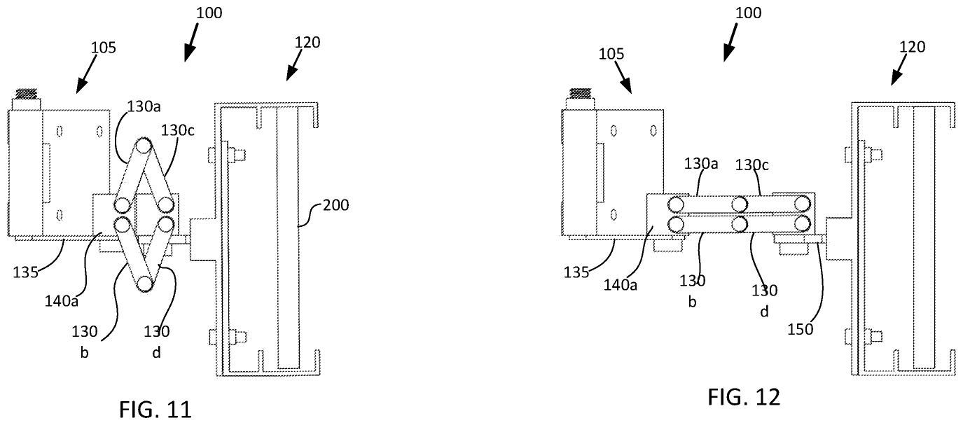

A first mounting block 140 is attached to an upper surface of the first sub-arm 135, such as by threaded fastener, adhesive, integral molding, or other operable means. A first set of scissor rods, comprising first upper scissor rod 130a and first lower scissor rod 130b, are pivotally attached at first ends thereof to a first side 140a of the mounting block 140 (see FIGS. 5, 9, 11). Second ends of said first scissor rods 130a and 130b are pivotally attached, respectively, to first ends of second upper scissor rod 130c and second lower scissor rod 130d. Second ends of said second scissor rods 130c and 130d are pivotally attached to a first side 145a of second mounting block 145. Second mounting block 145 is pivotally attached to a second sub-arm 150 distal the anchoring base 105 and proximate the frame clamp 120. Another set of first and second scissor rods 130 are attached to opposite, second sides of mounting blocks 140 and 145. Pivotal attachment of the second mounting block 145 to the second sub-arm 150 may be via passage of a threaded screw or machine bolt through an aperture in the second sub-arm 150 into a threaded bore in the second mounting block 145, or by other pivotal attachment means known in the art.

The second sub-arm 150 is attached to a frame clamp mounting block 155 that supports the main body of the frame clamp 120. Typically, the frame clamp mounting block 155 is itself attached to or an integral part of the upper jaw 125a of the frame clamp 120 and projects from the rearward face or side of the upper jaw 125a. In the embodiment shown in the drawings, a threaded member 157 of the second sub-arm 150 passes through a rearward facing aperture of the frame clamp mounting block 155 to engage a threaded nut 160 held within the mounting block 155. The nut 160 is tightened sufficiently to hold the frame clamp 120 and frame 200 in fixed position upon the second sub-arm 150 via friction but also allowing the frame clamp 120 to be manually turned and rotated about the axis of the threaded member 157 to, for example, rotate the disposition of the frame clamp 120 and frame 200 held within 180 degrees.

As noted previously, the frame clamp 120 may comprise cooperating jaws 125a and 125b that may move relative to one another to enlarge or reduce the space between the jaws to accommodate larger or smaller frame 200 sizes. In the embodiment shown in the figures, the upper jaw 125a is fixed to the second sub-arm 150 and the lower jaw 125b slides relative to the upper jaw 125a. As shown in FIGS. 5, 6, 9-12, slots in the upper and lower jaws 125a, 125b are aligned parallel and to substantially overlie one another. Two bolts 165a and 165b are passed through both slots to hold the jaws 125a, 125b in parallel position. Two nuts 167a and 167b are threaded onto the bolts 165a, 165b and tightened when desired to hold the jaws 125a, 125b in a fixed position relative to each other thus establishing a fixed distance between the jaws 125a, 125b. In practice, the nuts 167a, 167b and bolts 165a, 165b are loosened relative to each other and the jaws 125a, 125b opened sufficiently to accept a frame 200. The jaws 125a, 125b are then closed upon the frame 200 to hold it securely and the nuts and bolts tightened to avoid movement and loosening of the jaws.

It is to be understood that while certain forms of this invention have been illustrated and described, it is not limited thereto.

Having thus described the invention, what is claimed as new and desired to be secured by Letters Patent is:

1. A corner wall mount comprising:
an anchoring base comprising one or more base plates for attaching said anchoring base to a wall, or adjoining walls, of a room;
an extendable arm attached to said anchoring base at a proximate end of said extendable arm, said extendable arm projecting outward from said anchoring base; and
a frame clamp attached to a distal end of said extendable arm for holding picture frames or the like therein for display.

2. The corner wall mount of claim 1 wherein said anchoring base comprises two base plates hingedly connected to one another, said base plates pivotable around the axis of the hinge therebetween to attain angles relative to one another from approximately 180 degrees to approximately 90 degrees.

3. The corner wall mount of claim 1 further comprising holes in said base plates to accept screws or similar attachment devices to anchor said base plates to one or more wall surfaces.

4. The corner wall mount of claim 1 wherein said extendable arm comprises scissoring sub-structures for allowing said extendable arm to extend or contract in length.

5. The corner wall mount of claim 1 wherein said extendable arm comprises scissor rods pivotally attached to one another so that as the scissor rods pivot relative to one another the extendable arm extends or retracts.

6. The corner wall mount of claim 1 comprising a pivoting frame clamp pivotally attached to said distal end of said extendable arm at a pivoting point.

7. The corner wall mount of claim 2 wherein said extendable arm pivots around the axis of said hinge so that said extendable arm may be pivoted to any selected position along the arc between said two base plates.

8. The corner wall mount of claim 2 wherein said base plates are hingedly connected to one another at each base plate hinge knuckles by a hinge pin passing through axially aligned bores in said hinge knuckles.

9. The corner wall mount of claim 8 wherein said extendable arm is attached to and pivots around said hinge pin.

10. The corner wall mount of claim 6 wherein said frame clamp comprises cooperating jaws that may be selectively opened or closed relative to each other to reduce or enlarge the space therebetween for holding a frame.

11. The corner wall mount of claim 6 wherein said frame clamp may be rotated about said pivoting point.

12. The corner wall mount of claim 6 wherein said frame clamp is tiltable up or down, or side to side about said pivoting point.

13. The corner wall mount of claim 1 comprising a resilient material such as plastic.

14. The corner wall mount of claim 1 comprising primarily a plastic material selected from the group consisting of acrylonitrile butadiene styrene, recycled composite plastic material, and high-density polyethylene (HDPE).

15. A corner wall mount comprising:
an anchoring base comprising base plates attached to one another at a substantially ninety-degree angle for attaching said base plates to adjoining walls at the corner of a room;
an extendable arm attached to said anchoring base at a proximate end of said extendable arm, said extendable arm projecting outward from said anchoring base; and
a pivoting frame clamp attached to a distal end of said extendable arm at a pivoting point, said pivoting frame clamp comprising jaws that may be selectively opened or closed relative to each other for holding various size picture frames or the like therein for display, said pivoting frame clamp tiltable up or down, or side to side about said pivoting point.
